(19) United States
(12) Patent Application Publication
(10) Pub. No.: US 2025/0175117 A1
(43) Pub. Date: May 29, 2025

(54) INSTALLATION SYSTEM FOR PHOTOVOLTAIC PANELS

(71) Applicants: KONSTANTINOS BANIAS, ATHENS (GR); NIKOLAOS SIATIS, ATHENS (GR)

(72) Inventor: NIKOLAOS SIATIS, ATHENS (GR)

(21) Appl. No.: 18/725,211

(22) PCT Filed: Dec. 23, 2022
(86) PCT No.: PCT/GR2022/000074

§ 371 Date: Jun. 28, 2024

(30) Foreign Application Priority Data
Dec. 29, 2021 (GR) 20210100917

(51) Int. Cl. H02S 20/24; H02S 30/10

(52) U.S. Cl. CPC H02S 20/24; H02S 30/10

(57) ABSTRACT

The invention refers to a photovoltaic panel mounting system, consisting of a floor base (1), a low base (2), a high base and connecting rails (3). The floor base (1) has a double-sided tape (8) through which it is fixed onto the roofs (4). The high base is formed by a lower part (5) and an upper part (6), while for additional height one or more intermediate parts (7) can be inserted. The floor base (1) and the low base (2) or the lower part (5) of the high base are fixed together thanks to the use of a screw (13) placed in a semi-cylindrical longitudinal screw socket (12) as well as the use of connection protrusions (11).

### FIELD OF ART

The invention refers to the wider field of the mechanical engineering, lighting and heating. In particular, it refers to the field of solar heat collectors and the field of energy production systems from solar radiation. Even more specifically it refers to assemblies of fixed supports or supports for solar panel units and photovoltaic panels. Specifically, it refers to a photovoltaic panel installation system.

### BACKGROUND OF THE INVENTION

The solar panel mounting system disclosed in the present invention has not been disclosed in the prior art.

To date, the issue of installing photovoltaic panels on roofs is one of the ways that have been proposed to address the effects of climate change. Much of the roofs of existing buildings are flat roofs with or without insulation. When installing the photovoltaic panels, mounting is done with anchors or plugs, which fix the materials to the roof. It goes without saying that roof waterproofing after installation is necessary and sometimes insufficient, as areas are created where corrosion may occur.

As a response to the above problem, systems have been developed that cause less damage to the roof surface, while recently systems for supporting photovoltaic panels on a flat roof by gluing have been developed.

It is thus an object of the present invention to advantageously address the aforementioned disadvantages and shortcomings of the prior art by proposing a photovoltaic panel mounting system that does not require piercing the insulation or the roof.

It is a further object of the present invention to provide a photovoltaic panel mounting system that is easily produced and assembled with minimal use of other components.

A further object of the present invention is to provide a system for mounting photovoltaic panels, the system having double-sided tapes for its application to the respective roof. An important feature and advantage of the invention is that the system bears the weight of the photovoltaic panels in such a way that when the components are loaded vertically, an elastic deformation occurs which forces the joint configurations of the component and the carrier on the floor to come into constant contact, increasing the required traction force on the longitudinal axis, due to the large friction surface.

A further object of the invention is to present a solar panel mounting system, which ensures stability in loading on the transverse axis of the frame being formed, thanks to its design.

Another characteristic and advantage of the invention is that it has a screw that ensures stability against loading on the longitudinal axis of the photovoltaics mounting frame.

A further advantage of the present invention is that it provides quick and simple installation, without requiring the presence of specialized personnel.

An advantage of the present invention is also that the dimensions and weight of the materials used are particularly small and low, with the consequence of providing ease in the management of the materials during installation.

A characteristic of the invention is that it is made of recyclable materials, mainly aluminum, contributing to the protection of the environment.

An additional advantage of the invention is that the photovoltaic panel mounting system can be installed in both meridian and equatorial orientations.

An additional advantage is that the placement of ballast, where required, is easy, since it is done on the connection rules, which also have the appropriate configuration.

These and other objects, features and advantages of the invention will become apparent in the following detailed description.

### BRIEF DESCRIPTION OF THE DRAWINGS

The invention will become apparent to those skilled in the art by reference to the accompanying drawings in which it is illustrated in a non-limiting manner.

FIG. 1 shows the installation side of the floor base on the roof with the double-sided tapes used for its installation.

FIG. 2 is a three-dimensional perspective view of the floor base of the present invention.

FIGS. 3 (a)-(b) show the low base of the photovoltaic panel mounting system in perspective and in 3D illustration.

FIGS. 4 (a)-(b) show in a front and 3D view the lower part of the high base of the photovoltaic panel mounting system.

FIGS. 5 (a)-(b) illustrate in front view and in a three-dimensional representation the upper part of the high base of the photovoltaic panel mounting system.

FIGS. 6 (a)-(b) show the front view and the 3D representation of the low base of the system, when it is used as a terminal base.

FIGS. 7 (a)-(c) show in a front view the floor base assembled with the low base of the system, when it is intermediate and terminal, as well as the floor base with the high base of the system. The high base also features an intermediate component, between the lower and upper components, to further increase its height.

FIG. 8 is a front view of the floor base with the high base of the system, alongside the use of a wind barrier to protect the installation from crosswinds.

FIG. 9 is an illustrative embodiment of the photovoltaic panel mounting system with equatorial installation.

FIG. 10 is an embodiment with carriers for roofs that have a limitation as regards the weight they can accept.

### DETAILED DESCRIPTION OF THE PREFERRED EMBODIMENT

Referring now to the accompanying drawings, we will describe illustrative embodiments and how to install the solar panel mounting system to highlight both its innovative features and benefits.

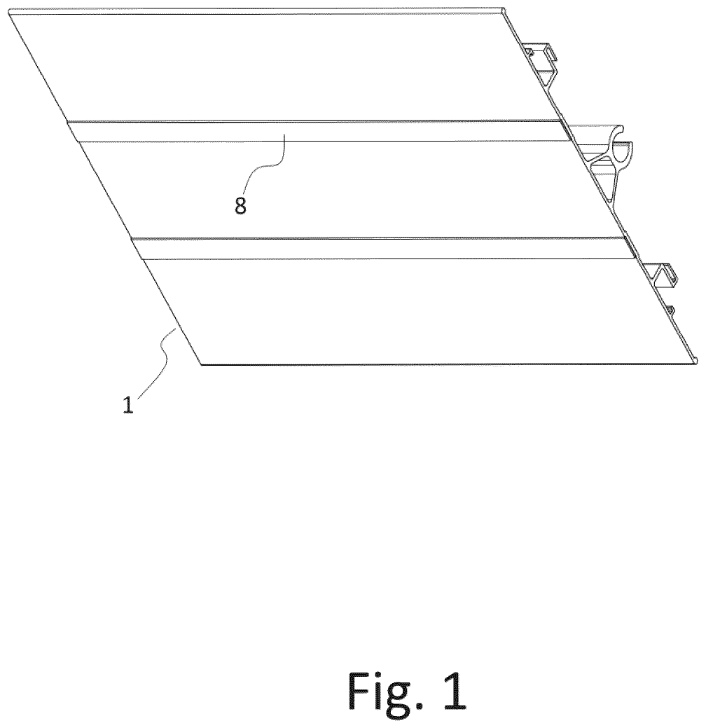

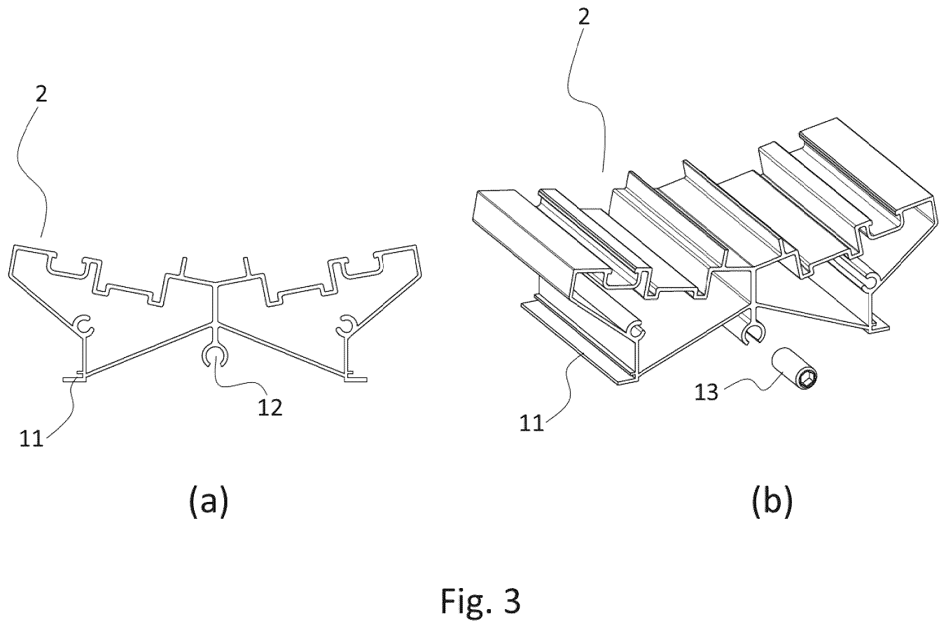

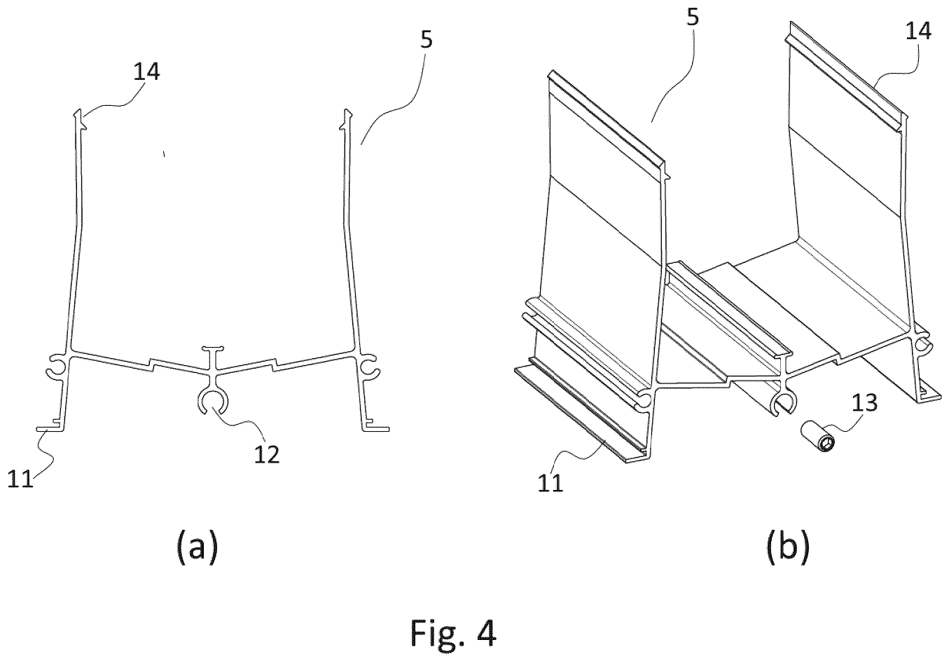

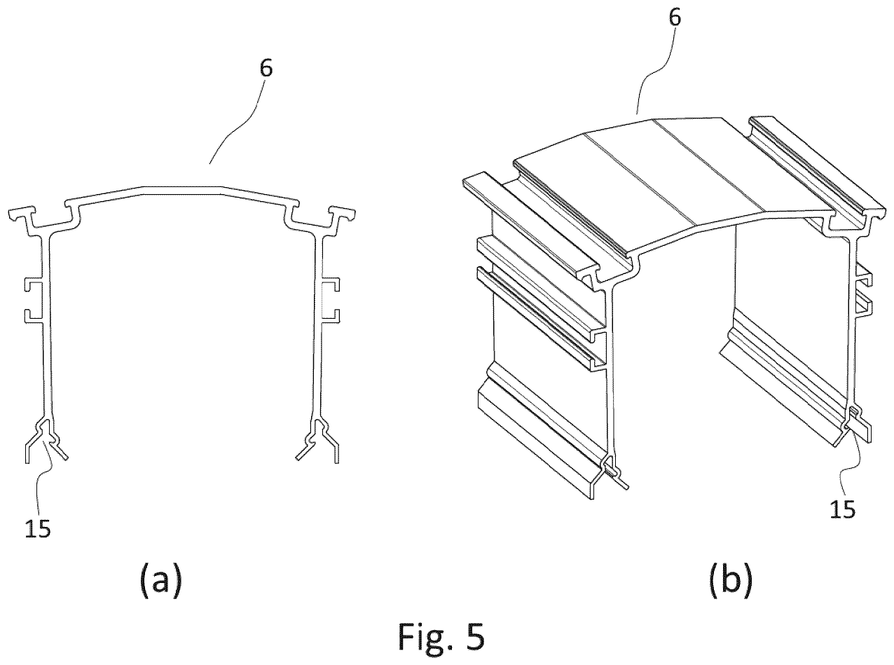

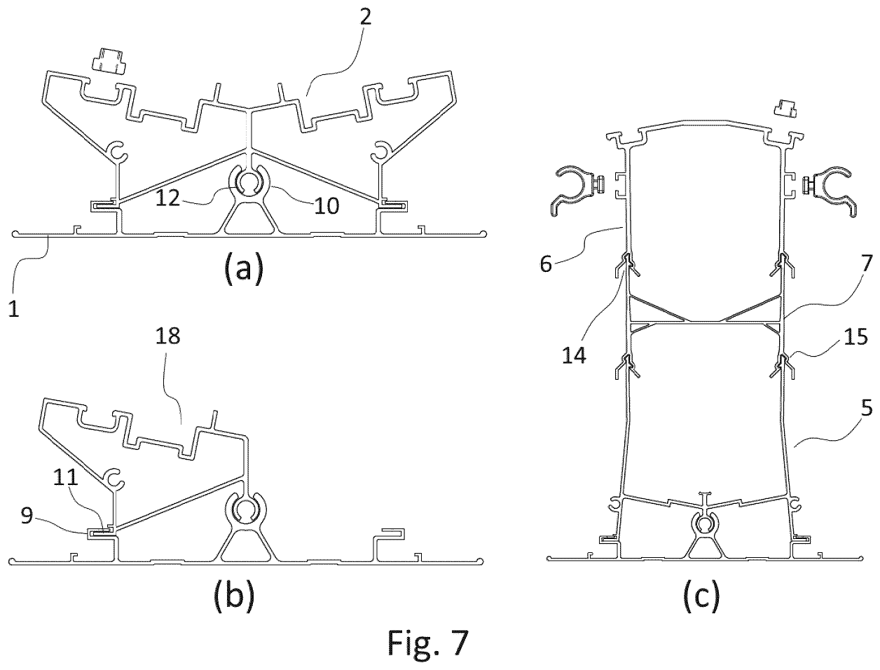

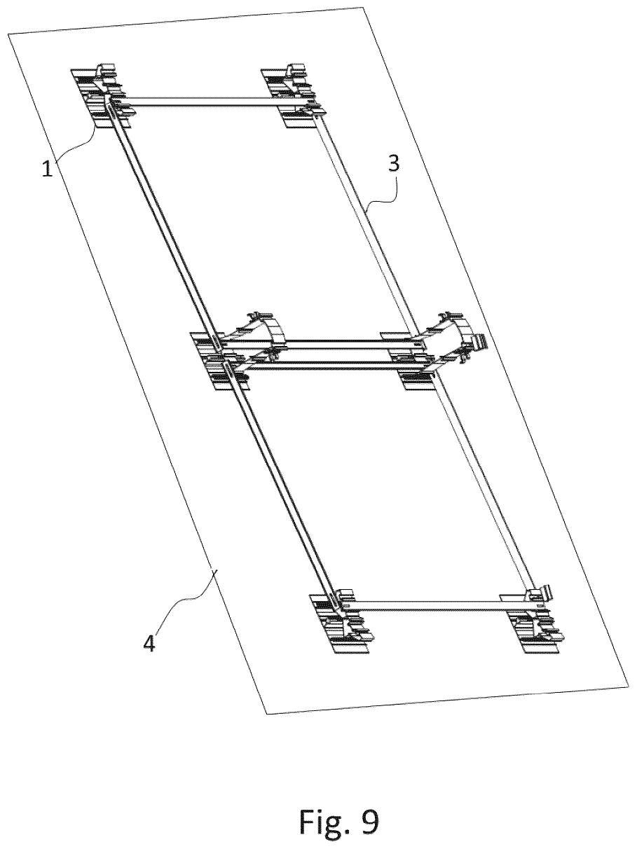

The main elements of the PV panel mounting system are the floor bases (1), FIG. 1, the low bases (2), FIG. 3 (b) the high bases and the connecting rails (3), FIG. 9, between the bases on the roof (4). The high bases have a lower part (5), FIG. 4 (b), which is connected to the respective floor base (1) and an upper part (6), FIG. 5 (b) on which the corresponding photovoltaic rests. Between the lower part (5) and the upper part (6) one or more intermediate parts (7) may be inserted, FIG. 7 (c), to further increase the height of the high base.

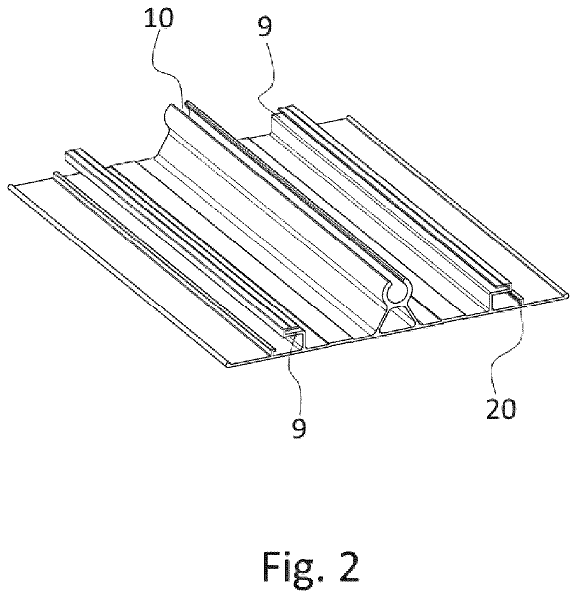

The placement of the floor base (1) and its fixing to the roof (4) of each building is done using at least one double-sided tape (8), avoiding drilling the surface. The floor base (1) has two elongated slots (9), FIG. 2, and a semi-cylindrical central channel (10), which are the sockets for the connection to the low base (2) or to the lower part (5) of the high base. For this reason, the specific elements have connecting protrusions (11), FIG. 3 (a) and FIG. 4 (a), but also a semi-cylindrical longitudinal screw socket (12). By placing a screw (13) along the longitudinal axis of the connection, the walls of the semi-cylindrical screw socket (12) expand and come into contact with the walls of the semi-cylindrical central channel (10), increasing the pull-out resistance. In an alternative embodiment and for reasons of increased strength, there is the possibility of placing two screws (13) at the ends of the screw socket (12). The attachment of the connecting protrusion (11) of the low base (2), FIG. 7(a), or the lower part (5) of the high base with the corresponding elongated notch (9) of the floor base (1), can be strengthened by plastic deformation of the aggregate, using tongs, pincers or other suitable tool and applying the relevant pressure. In an advantageous implementation of the invention, a screw can be placed perpendicular to the aggregate of the connection projection (11) and the elongated notch (9) to connect the two elements even more strongly.

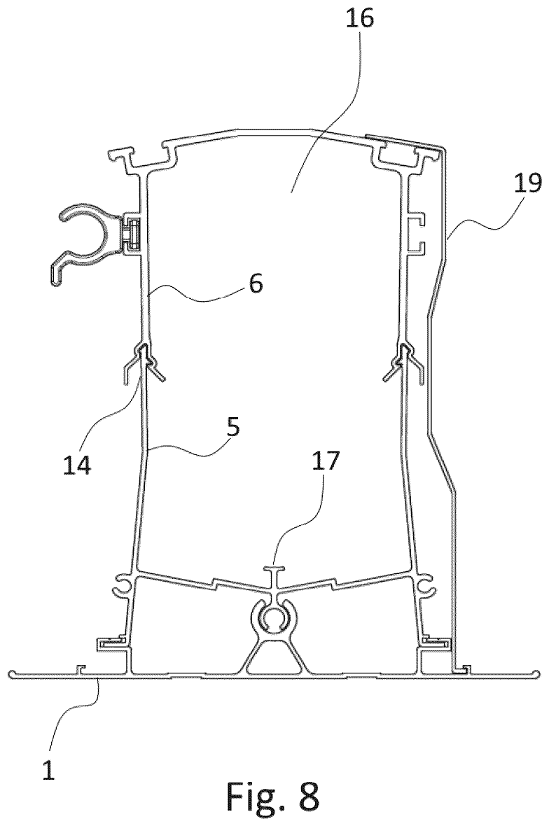

The connection of the lower part (5) with the upper part (6) of the high base is made thanks to a special configuration of these parts, FIG. 8. Thus the lower part (5) has toothed ends (14), which enter the corresponding sockets (15) of the upper part (6), FIG. 5 (a). In case of application of one or more intermediate components (7), it is understood that the intermediate components (7) have at the upper end the toothed ends (14) and at the lower end corresponding sockets (15) for a snap connection between them. The vertical or random loading of the interconnected parts (5), (6), (7) of the high base elastically deforms the parts so that they come to a position that offers the greatest support.

The lower part (5) and the upper part (6), being assembled together, form an intermediate space (16) in which the appropriate ballast is placed, when this is deemed necessary by design and given the conditions. The placement of the ballast is done on a special configuration (17) to transfer the stresses. In the case of a high base with the use of intermediate parts (7), the intermediate spaces (16) that are formed are more than one and therefore they can all be used for placing ballast.

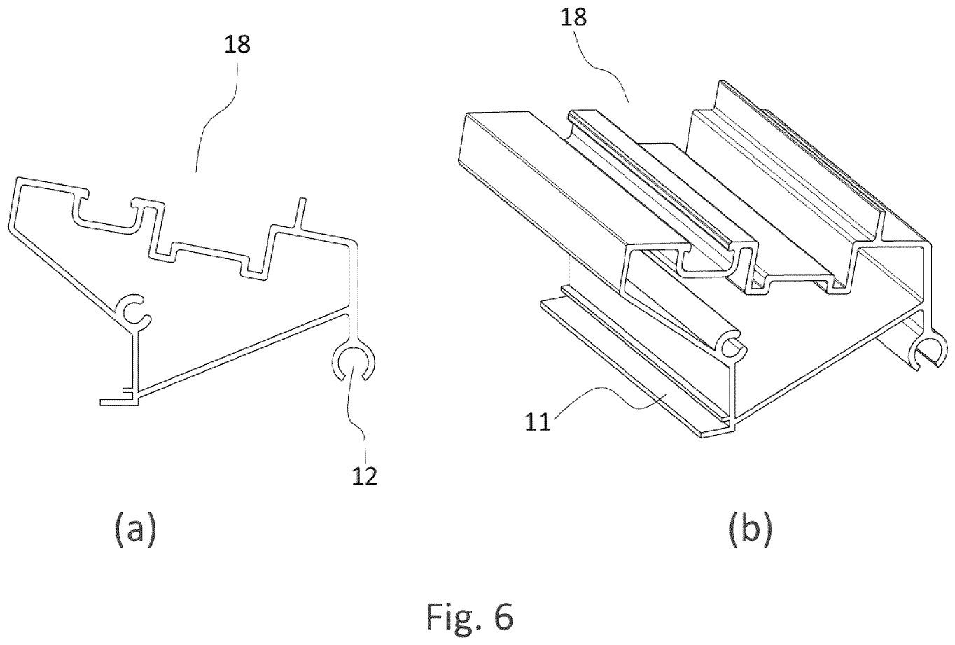

When installing the PV panel mounting system, there are low bases (2) which, instead of being intermediate and on which PVs are placed on either side, are terminal, with only one side supporting a PV, FIG. 7(b). For this reason there is also a terminal low base (18), FIG. 6(b). The terminal low base (18) does have a semi-cylindrical longitudinal screw socket (12), FIG. 6(a), but only one protrusion (11) for connecting with the corresponding elongated slot (9) of the floor base (1). By using the low base terminal (18) there is also a relative material saving.

In an advantageous embodiment of the invention and in case there is an increased possibility of wind gusts, in one direction, the photovoltaic panel mounting system can be protected by a wind barrier (19), preferably made of steel. The molded wind barrier (19) is fixed in a channel (20) of the floor base (1) and extends vertically to the top of the high base.

Given that the connection rails (4) between the low and high bases are of variable length, it is secured that the system positioning as also the base placement is simple, since the installation of one of them also defines the position of the next one.

In cases where this is deemed necessary and given that the aluminum extrusion products are produced in great lengths, it is possible to change the lengths of the system components. This means that the floor base (1), the low base (2), the terminal low base (18), the lower part (5), the upper part (6) and the intermediate part (7) of the high base can change in length, simultaneously changing their mechanical properties, giving different mechanical resistances. In such a case, adhesion of the floor base (1) to the ground changes, the surface of the double-sided tape (8) used being also changed.

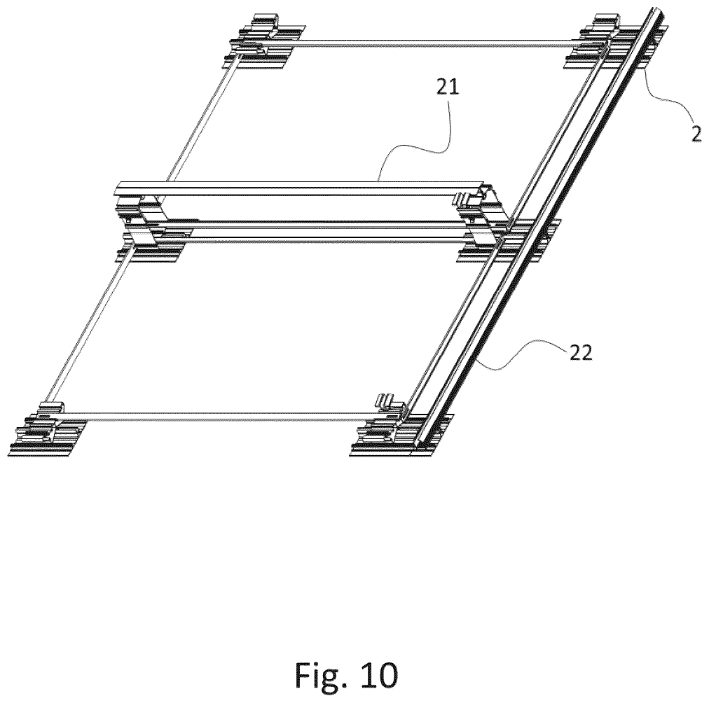

Alternatively and in cases where the roof (4) cannot bear a significant weight, due to construction or age, there is the possibility of connecting two adjacent high bases together with a purlin (21), FIG. 10, while a corresponding connection with another purlin (22) is done vertically between the three consecutive low bases (2). In this way, a spatial network is created that does not require the existence of ballast or that in general requires significantly lighter ballast, for the effective retention of the system. In this way, the stability of the elements against wind gusts is ensured, even without the addition of ballast.

It should be noted at this point that the description of the invention was carried out with reference to illustrative implementation examples, to which it is not limited. Consequently, any change or modification regarding the shape, dimensions, morphology, materials used and construction and assembly components, as long as they do not constitute a new inventive step and do not contribute to the technical development of what is already known, are considered included in the purposes and objects of the present invention as summarized in the following claims.

1. Photovoltaic panel mounting system, consisting of a floor base (1), a low base (2), a high base, formed by a lower part (5) that connects with an upper part (6) and connecting rails (3), where the floor base (1) has on its lower part double-sided tapes (8) for fastening to the roof (4), characterized in that the floor base (1) has on its upper part two elongated slots (9) and a semi-cylindrical central channel (10) within which corresponding connecting protrusions (11) fit and semi-cylindrical longitudinal screw socket (12) of the low base (2) or the lower part (5) of the high base, applying at least one screw (13) along the socket (12).

2. The photovoltaic panel mounting system, according to claim 1, characterized in that the lower part (5) has toothed ends (14) fitting in corresponding sockets (15) of the upper part (6).

3. The photovoltaic panel mounting system, according to claim 1, characterized in that between the lower part (5) and the upper part (6) at least one intermediate part (7) is inserted.

4. The photovoltaic panel mounting system, according to claim 1, characterized in that the lower part (5) has a special configuration (17) for placing ballast.

5. The photovoltaic panel mounting system, according to claim 1, characterized in that the floor base (1) has a channel (20) for mounting a wind barrier (19), elevating parallel to the high base.
